(19) United States
(12) Patent Application Publication
(10) Pub. No.: US 2013/0218526 A1
(43) Pub. Date: Aug. 22, 2013

(54) Identifying A Highly Diverse Set Of Multi Objective Designs

(71) Applicants: Greenberg Lev, Haifa (IL); Masin Michael, Haifa (IL); Shir Ofer, Jerusalem (IL); Zadorojniy Alexander, Haifa (IL)

(72) Inventors: Greenberg Lev, Haifa (IL); Masin Michael, Haifa (IL); Shir Ofer, Jerusalem (IL); Zadorojniy Alexander, Haifa (IL)

(73) Assignee: INTERNATIONAL BUSINESS MACHINES CORPORATION, Armonk, NY (US)

(21) Appl. No.: 13/401,860

(22) Filed: Feb. 22, 2012

(51) Int. Cl. G06F 17/50

(52) U.S. Cl. 703/1

(57) ABSTRACT

A method of identifying a set of designs compliant with one or more constraints. The method comprises providing an objective space of one or more objectives and a design variables space, examining a plurality of designs which comply with one or more constraints of one or more objectives, identifying, according to the examination, a high diversity set comprising members from the plurality of designs which have corresponding design variables in the design variables space with a diversity value that is greater than a respective diversity value pertaining to at least one set of members from the plurality of designs, and outputting the high diversity set.

### BACKGROUND

The present invention, in some embodiments thereof, relates to design and, more specifically, but not exclusively, to methods and systems of design selection

Multi-objective optimization, also known as multi-objective programming or multi-criteria or multi-attribute optimization is the process of simultaneously optimizing two or more objectives, optionally conflicting, subject to certain constraints. Multi-objective optimization extends single objective optimization and can be found in various fields: product and process design, finance, aircraft design, the oil and gas industry, automobile design, or wherever optimal decisions need to be taken in the presence of trade-offs between two or more conflicting objectives. Maximizing profit and minimizing the cost of a product; maximizing performance and minimizing fuel consumption of a vehicle; and minimizing weight while maximizing the strength of a particular component are examples of multi-objective optimization problems.

Sometimes, a single solution that simultaneously optimizes all objectives is not found but rather a number of tentative solutions which comply with respective constraint(s). In such cases, solutions are not eliminated from consideration by replacing them with other solutions. One of the most common approaches for multi-objective optimization is to generate the whole or partial efficient frontier.

In addition, existing methods to find near-optimal solutions with the greatest diversity of design variable values are based upon Evolutionary Algorithms (EAs), where the coined terminology is decision-space diversity.

### SUMMARY

According to some embodiments of the present invention, there is provided a method of identifying a set of designs compliant with one or more constraints. The method comprises providing an objective space of at least one objective and a design variables space, examining a plurality of designs which comply with at least one constraint of the at least one objective, identifying, according to the examination, a high diversity set comprising members from the plurality of designs which have corresponding design variables, in the design variables space, with a greater diversity value than the diversity value of respective corresponding design variables of a set from at least one set from the plurality of designs, and outputting the high diversity set.

According to some embodiments of the present invention, there is provided a computer program product for identifying a set of designs compliant with one or more constraints, the computer program product comprises a computer readable storage medium having computer readable program code embodied therewith, the computer readable program code comprising: computer readable program code configured to provide an objective space of at least one objective and a design variables space; computer readable program code configured to examine a plurality of designs which comply with at least one constraint of any of the at least one objective; computer readable program code configured to identify, according to the examination, a high diversity set comprising members from the plurality of designs which have corresponding design variables, in the design variables space, with a greater diversity value than respective corresponding design variables of a set from at least one set from the plurality of designs; and computer readable program code configured to output the high diversity set.

According to some embodiments of the present invention, there is provided a system of identifying a set of designs compliant with a plurality of constraints of one or more objectives. The system comprises a processor, a database which defines an objective space of at least one objective and a design variables space, a designs module which examines a plurality of designs which comply with at least one constraint any of the at least one objective and identifies accordingly a high diversity set comprising members from the plurality of designs which have corresponding design variables in the design variables space with a diversity value that is greater than a respective diversity value pertaining to at least one set of members from the plurality of designs, and an output interface which outputs the high diversity set.

According to some embodiments of the present invention, there is provided a method of a computer program product stored on a computer-readable medium. The computer program product comprises a computer program code, for a method of identifying a set of designs compliant with a plurality of constraints of at least one objective, comprising: providing an objective space of at least one objective and a design variables space; examining a plurality of designs which comply with at least one constraint of any of the at least one objective; identifying, according to the examination, a high diversity set comprising members from the plurality of designs which have corresponding design variables in the design variables space with a diversity value that is greater than a respective diversity value pertaining to at least one set of members from the plurality of designs; and outputting the high diversity set.

According to some embodiments of the present invention, there is provided a method of identifying a set of designs compliant with one or more constraints, comprising: providing an objective space of at least one objective and a design variables space; examining a plurality of designs which comply with at least one constraint of any of the at least one objective; calculating an efficient frontier in the objective space according to the at least one constraint; identifying, according to the examination, a high diversity set comprising members from the plurality of designs which having a minimal distance from the efficient frontier and have corresponding design variables in the design variables space with a predefined diversity value; and outputting the high diversity set.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of identifying a set of designs in an objective space so that design variables of members of the set have a diversity value that is greater than the diversity value of design variables of one or more design set(s) that comply with one or more constraints in the objective space, according to some embodiments of the present invention;

FIG. 2 is a relational view of software components of a system of identifying a set of designs, according to some embodiments of the present invention;

FIG. 3 is a graphical representation of a plurality of designs in an objective space and their respective corresponding design variables in a design variables space, according to some embodiments of the present invention;

FIG. 4A depicts two dimensional (2D) graphs wherein multi objective designs (right graph) are depicted as points; each multi objective design complies with a certain set of constraints and associated with two variables which are represented by a point in the left 2D graph, according to some embodiments of the present invention; and

FIG. 4B is a 2D graphs wherein multi objective designs are depicted as points (right graph); each multi objective design complies with a certain set of constraints and associated with three variables which are represented by a point in the right three dimensional (3D) graph, according to some embodiments of the present invention.

### DETAILED DESCRIPTION

The present invention, in some embodiments thereof, relates to design and, more specifically, but not exclusively, to methods and systems of identifying a highly diverse set of multi objective designs.

According to an aspect of some embodiments of the present invention there are provided methods and systems for identifying a high diversity set of designs, which comply with one or more constraints. The high diversity set has a high, optionally the greatest, design variables diversity value in relation to the design variables diversity value of one or more sets of designs in the objective space. The methods and systems allow finding architectures with sufficient multi-objective Pareto optimality and high, optionally maximal, diversity of their design-variable values. Diversity in the design-variable space of selected designs is of much interest as a vehicle to find the rich collection of product and process designs (also referred to herein as architectures) that employ different mechanisms to achieve the same goal. Important considerations that determine an efficacy of a multi objective design are difficult or impractical to model in an objective function, for example strategic alignment, competitive positioning, intellectual property, supplier capabilities, manufacturability, and/or market desirability. Therefore, it is competitively advantageous to be able to generate a comprehensive list of the diverse architectures spanning in an objective space, all mapped onto the proximity of the efficient frontier, and evaluate them both quantitatively and qualitatively to assist in finding those with a high, optionally the greatest, real value.

Optionally, the process of identifying the high diversity set is iterative. Optionally, the process of identifying the high diversity set is based on an efficient frontier algorithm wherein suitable designs which comply with the constraints are identified.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident, software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

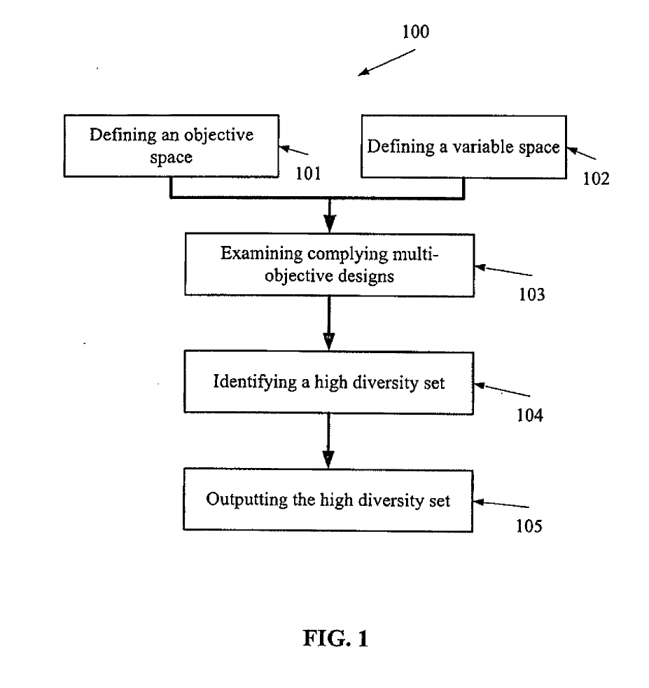

Reference is now made to FIG. 1 which is a flowchart of a method 100 of identifying a high diversity set of designs, in an objective space which are compliant with one or more constraints of one or more objectives, optionally conflicting, according to some embodiments of the present invention. The design variables of the designs in the high diversity set have a diversity value greater than the diversity value of design variables of one or more sets of designs which comply with the constraint(s) in the objective space. Optionally, the high diversity set is calculated using a second order approximation algorithm.

As used herein, a design may be any design which has one or more objectives, optionally conflicting, for example a product design, a process design, a financial design, an aircraft design, a mechanical design, an oil and gas industry design, an automobile design, and/or a design having variables which have to be set in the presence of trade-offs between two or more conflicting objectives. The tradeoff maybe any condition that involve reducing one quality or aspect of something in return for a gain in another quality or aspect. Conflicting objectives may be budget variables versus performances variables, gas consumption versus velocity, size versus volume, and/or the like.

The method allows providing a high diversity set of diverse designs by an exploration of the design variables space. The set allows a designer to review a wide spectrum of the possible solutions to make a decision which one to choose (sometimes based on his personal experience). Unlike common processes for multi objective design optimization, the method does not have to be heuristic so that all or most feasible design variables which reflect in an approximation of non-dominant objective functions realization may be explored, for example as described below. In such a manner, optimality may be guaranteed. Moreover, the number of iterations, which are required to implement the process, may be relatively low.

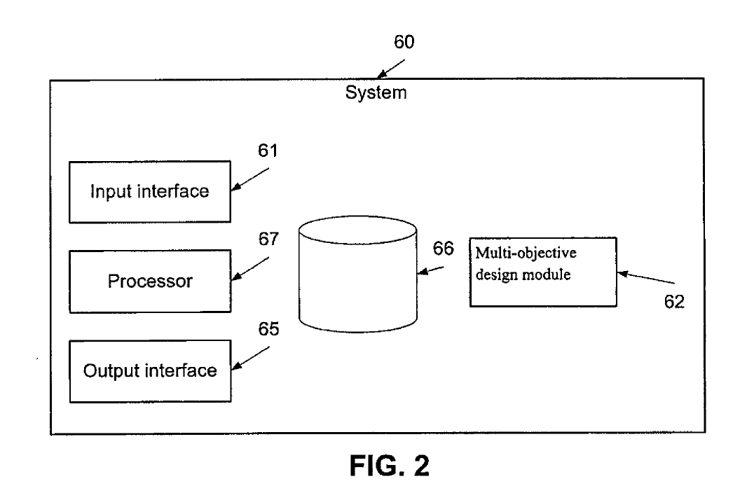

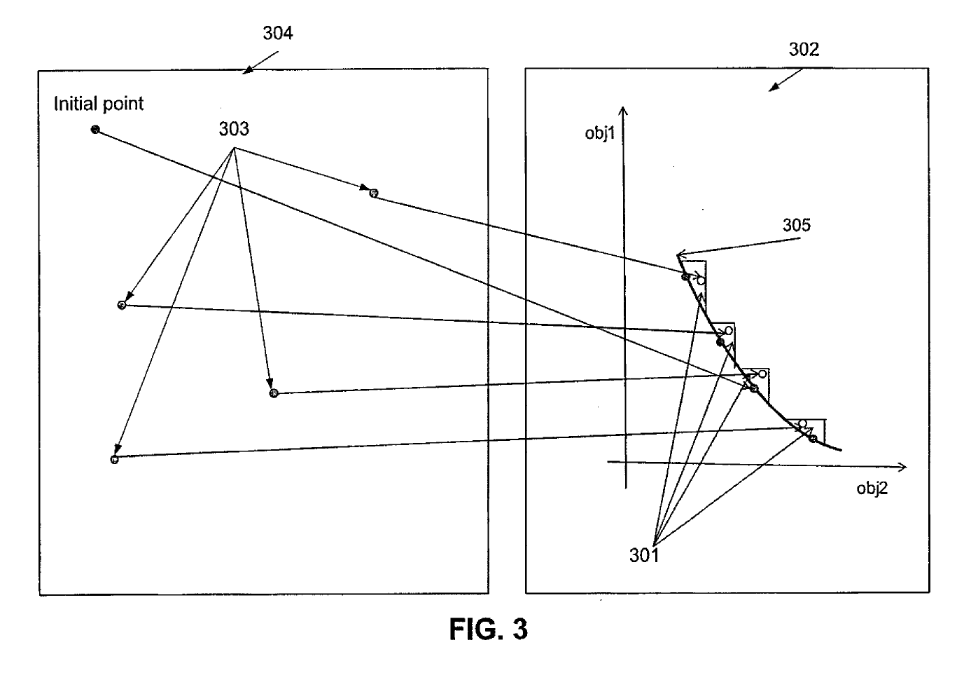

Reference is also made to FIG. 2, which is a relational view of software components of a system 60 of identifying a set of designs that may be used for implementing the above method 100, according to some embodiments of the present invention. As shown, the system 60 includes a processor 67 and software components include an input interface 61, a design module 62, and an output interface 65. The lines in FIG. 3 depict optional and non limiting data flow between the modules. The system 60 may be implemented in a client terminal hosting a design platform, for example as a feature of the design platform and/or an add-on thereto. The system 60 may be implemented in software as a service (SaaS) that is hosted centrally and accessed by users using a client module, such as a web browser, over the Internet or an Ethernet.

First, as shown at 101, 102, an objective space and a design variables space are defined. The objective space may be represented as a set of values stored in a database 66, for example a list of a plurality of objectives and one or more constraint(s) each defines which possible values fulfill a respective objective. The plurality of objectives and respective constraints may be provided by a user interface. The design variables space may be represented as a set of values stored in the database 66. The design variables space optionally represents which design variables are feasible. The design variables space may be defined by a user interface.

Now, as shown at 103, the system 60, for example the design module 62, examines possible designs which comply with one or more constraints of one or more objectives, optionally conflicting, in the objective space. Each one of the designs has corresponding design variables in a design variables space.

As shown at 104, the examination, which is optionally iterative, allows identifying a high diversity set that includes two or more designs which comply with the one or more constraints. The high diversity set is optionally a maximal diversity set. The high diversity set is optionally selected so that a diversity value of corresponding design variables of its members is greater than the diversity value of at least'one of the corresponding design variables of designs that comply with the aforementioned constraint(s) of one or more respective sets.

For example, reference is now also made to FIG. 3, which is a graphical representation of the objective and variable design spaces 302, 304. The graphical representation depicting the objective space 302 includes a plurality of filled points indicative of a plurality of possible designs on an efficient frontier curve 305. During the aforementioned examination, in order to identify a high diversity set, the possible design, which is located on the efficient frontier curve 305, is adjusted within the boundaries of the constraints. Exemplary boundaries are depicted in areas around the filled points 301 to the right of the efficient frontier curve 305. In such embodiments, the compliance of designs with the aforementioned constraints may be verified by measuring a distance between optional points in the graph and the Pareto frontier curve 305. These areas 301 are indicative of search areas set according to one or more constraints, for example a maximum allowed distance from the Pareto frontier curve. In each area, an empty point is indicative of a diversity wise adjustment to the design that increases the diversity value in the design variables space, for example as described below. Each empty point is connected by a line to a variable point 303 in the design variables space 304. The variable point 303 represents selected variables in the design variables space 304. The selected variables and the possible adjustments are identified as further described below.

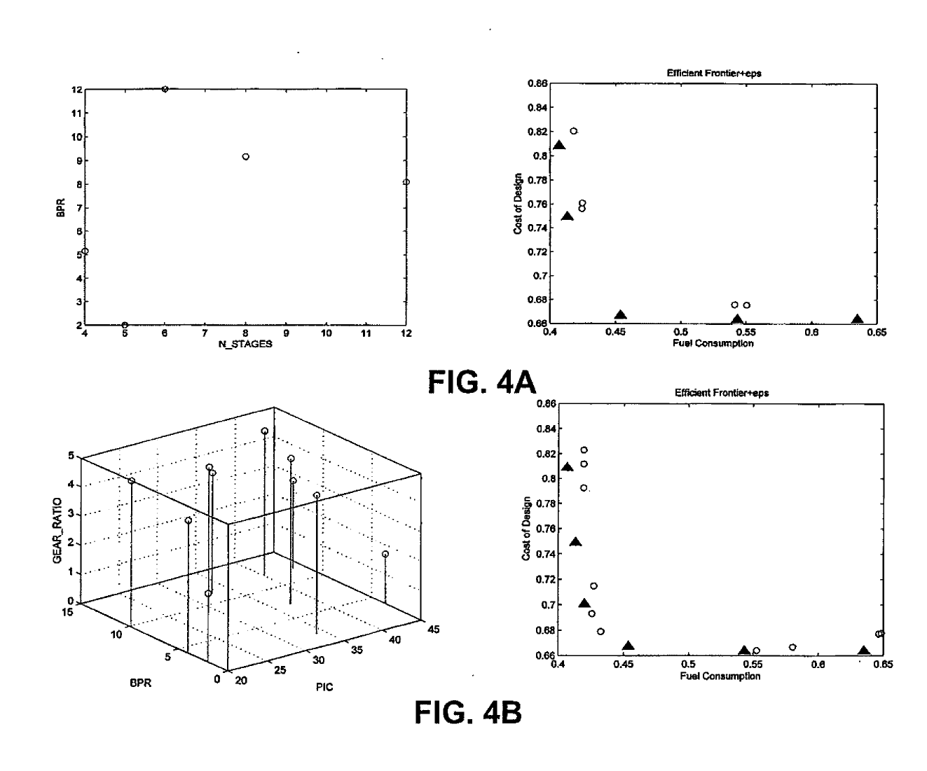

It should be noted that each design may have one or more objectives and associated with two or more variables in the design variables space. For example, FIG. 4A depicts points indicative of a number of multi objective designs which comply with certain constraints and associated with two design variables which are represented in a 2D graph. FIG. 4B depicts points (right graph) indicative of a number of multi objective designs which comply with certain constraints and associated with three variables which are represented in a 3D graph (left graph). In FIGS. 4A and 4B, red points are optimal points in a design variables space corresponding to a minimum objective and blue points are diverse set of solutions found by the process described above and exemplified below.

According to some embodiments of the present invention, members of the high diversity set are optionally selected so that the diversity value of corresponding design variables is higher than a threshold value. For example, the distance between points representing corresponding design variables in a multidimensional representation of the design variable space has to be no less than a threshold distance. In such a manner, the selected high diversity set may include designs which are as close as possible to an optimum, for example an optimum which is defined by the efficient frontier curve in the objective space.

This above allows, as shown in 105, outputting the high diversity set, for example in response to a query, as an output presented to a designer on a display of a computing unit executing the above method or on a client terminal that receives the output from a network node, such as a server.

For example, reference is now made to a number of algorithms of identifying a high diversity set of designs, according to some embodiments of the present invention. The algorithms are set to find a high diversity set among a plurality of possible sets which are upper bounded by one or more constraints in the objective space. The one or more constraints may be referred to herein as a maximum allowed distance from the given points on a frontier which is optionally a Pareto frontier.

For brevity, the following are held:
1. Without loss of generality, a multi-objective vector minimization problem is defined as follows minimize y=(f⁽¹⁾(x), f⁽²⁾(x), . . . , f^{(K)}(x)] where x ∈ X, X ⊂ Rⁿ denotes a set of feasible solutions, V ∈ R^{E} denotes its image in the objective space, and f:X→Y denotes an objective function that projects X to Y. If x ∈ X, then y=f (x) ∈ Y and the value of the t^{th} objective of solution x is y^{(t)}=f^{(t)}(x). For x₁, x₂ ∈ X, y_{L}=f (x_{L}), y₂=f(x₂) ∈ Y, let y₁=y₂ and y₁≦y₂ if y_{L}^{(t)}=y₂^{(t)} and yₜ^{(t)}≦y₂^{(t)} for all i, respectively. Two solutions x₁, x₂, ∈ X, yₜ=f(x₁), y₂=f(x₂) ∈ Y are equivalent if y₁=y₂<y₂ if y₁^{(t)}≦y₂^{(t)} for all i and y₁⁽ⁱ⁾<y₂⁽ⁱ⁾ for some i. In this case, y₂ is dominated by y₁(or yₜ dominates y₂).
2. A set X is a compact set and each of the objective functions f is continuous. Xₚₐᵣ denotes a complete set of Pareto optimal solutions in X, for example, solution x ∈ Xₚₐᵣ if and only if there is no xᵢ ∈ X such that f(xᵢ)<f(x). If solution x is Pareto optimal, then y=f(x) is referred to as efficient. The complete set of efficient points in the objective space, denoted herein as Y_{eff}, is an efficient frontier. As previously discussed, the set xₚₐᵣ may contain equivalent solutions, or in other words, a single efficient point y ∈ Y_{eff} maybe mapped onto multiple equivalent pre-images in Xₚₐᵣ. dₓ(∵) denotes a metric on X. For a metric a triangle inequality is satisfied, i.e., for all x₁, x₂, x₃ ∈ X, dₓ(x₁, x₂)≦dₓ(x₁, x₂)+dₓ(x₂, x₃). d_{E}(y) denotes a function representing a measure for distance from a set E in the objective space. For brevity, d_{E}(y)=min_{BBE}max_{i=L}_{ₘₐₓ}_{K}y^{(t)}/y_{B}⁽ⁱ⁾−1, where E c Y; however, other functions may be defined as well. According to above denotations, for any subset V ⊂ X and any point x ∈ X, dₓ(x,V)=min(dₓ(x,v)|v ∈ V). dₓ(x, V) is denoted by dᵥ(x). δ_{E} denotes a prescribed constant defining a maximally accepted distance away from a set E with respect to d_{z}(y). δᵥ denotes a prescribed constant defining the minimally accepted diversity of the resulting set V.

In the following section, Primal and dual maximum design diversity (MDD) algorithms for identifying a set of diverse multi objective designs are reviewed. In a Primal p-MDD algorithm the set V={v₁, . . . , xₚ} ∈ Sₚ is found, such that min_{1≦i≧j≦p}{dₓ(xᵢ, xⱼ)} is maximized and to Dual p-MDD where set V={x₁, . . . , xₚ} ∈ S_{d} is found , such that max_{1≦i≦p}d_{E}(f(xᵢ)) is minimized. In addition, the diversity in the design-variable space is enhanced by compromising the Pareto optimality by δ_{E} within the objective space and the diversity is expected to get higher as larger δ_{E} values are considered. In these algorithms Sₚ={V ⊂ X:d_{z}(f(x))≦δ_{g}, ∀ x ∈ V)} denotes a set of feasible solutions for Primal p-MDD and S_{d}={V ⊂ X:dₓ(x,V\{x})≧δ_{V}, ∀ x ∈ V} denotes a set of feasible solutions for Dual p-MDD.

Reference is now made to the primal MDD approximation algorithm wherein a partial efficient frontier, E, as well as an initial solution in the design-variable space, are identified, for example by weighted sum or DMA algorithm. Then, at each of a plurality of iterations, the algorithm adds the farthest solution in the design-variable space to an existing subset of feasible solutions. This algorithm is defined as follows:

Algorithm 1

```
(1) Initialize:
        (a) Find V₁ = {x₁} ⊂ X_{Par}, E ⊂ E_{eff}
        (b) Set V = V₁,
        δ_{g}= (maximal distance in objective space), j = 2,
        J =(maximal number of iterations).
(2) Solve Primal MDD optimization problem. If there is a feasible solution
then y* = f(x*) is the optimal solution, else go to Step 4.
(3) Set Vⱼ = Vⱼ₋₁ U {x*} and V = Vⱼ, j = j + 1. If j > J, go to Step 4,
otherwise go to Step 2.
(4) Return V.
```

In this algorithm if V denotes a set of designs (points in the design variables space) generated by the Algorithm then V is a 2—approximation solution of a Primal |V|-MDD problem. The Primal |V|-MDD problem is a problem of finding the set V={x₁, . . . , xₚ} ∈ Sₚ, such that min_{1≦i≧j≦p}(dₓ(xᵢ, xⱼ)} is maximized. This may be established based on the described in Tamir, A. Obnoxious facility location on graphs. SIAM Journal on Discrete Mathematics, 4(4):550--567, 1991, which is incorporated herein by reference. V′ denotes an optimal solution of Primal p-MDD problem with the optimal value of δ′, i.e., dₓ(x₁, x₂)≧δ′ for all distinct x₁, x₂ ∈ V′. In (2) of iteration j of the above Algorithm 1, for each x ∈ V′ with dᵥ(x)<δ′/2 there is a solution x̅ ∈ V such that dₓ( x̅, x)<δ′/2. Moreover, for each x̅ ∈ V there is at most one x ∈ V′ such that dₓ( x̅, x)<δ/2. That follows from dₓ(x₁, x₂)≧δ′ for all distinct x₁, x₂ ∈ V′ and the triangle inequality of metric dₓ(∵). In each iteration of (2) holds |V|<|V′|, therefore there exists a feasible solution x ∈ Ir^{*} with dᵥ(x)≧δ′/2. Finally, Primal MDD optimization problem, which is defined as Maximize dᵥ(x), subject to x ∈ X, y=f(x), d_{z}(y)≦δ_{E} maximizes dᵥ(x).

In this algorithm if V denotes a set of solutions generated by Algorithm 1, then ξ_{E}(V)≦δ_{z}. This may be established from Primal MDD optimization problem constraints which follow that each x ∈ V satisfies d_{E}(f(x))≦δ_{E}.

In this algorithm, a partial explored efficient frontier is used as an initial point and then, at each iteration, a most distinct solution to the existing variables set in the design variables space is added.

In such embodiments, as greater δ_{E} means a higher potential for diversity, a set having higher diversity in the design variables space is obtained by increasing the maximum allowed distance in the objective space.

Reference is now made to the dual MDD approximation algorithm that is used to Minimize d_{E}(y) subject to x ∈ X, y=f(x), dᵥ(x)≧δₚ. In the dual maximum design diversity approximation algorithm the compromise of Pareto optimality is minimized subject to a minimal distance in the design-variable space. Optionally, the algorithm allows choosing a lower bound on a distance is chosen at each iteration to allow finding a sufficient distance to guarantee it. A listing of the algorithm is as follows:

Algorithm 2

```
(1) Initialize:
        (a) Find V₁ = {x₁} ⊂ X_{Par}, E ⊂ E_{eff}
        (b) Set V = V₁,j = 2.
        J = (maximal number of iterations).
(2) Solve Dual MDD optimization problem. If there is a feasible solution
then y* = f(x*) is the optimal solution, else go to 4.
(3) Set Vⱼ = Vⱼ₋₁ U {x*} and V = Vⱼ, j = j + 1. If j > J, go to 4,
otherwise go to 2.
(4) Return V.
```

First, the design variables and objective spaces are initialized and a maximal number of iterations is set. Then, a Dual MDD optimization problem is solved and in (3) the existing set of design variables V is augmented by x* when x* is an optimal solution. Then, the procedure is repeated until the maximal number of iterations is reached or no feasible solution exists. In the final action, numerated as (4), the design-variable set V is returned. In this algorithm V₁^{opt}={argmin_{U}ξ_{E}(U):|U|=j, δᵥ=η} where V denotes a set of solutions generated by Algorithm 2 when δᵥ=η/2 and the number of iterations is j.

In Algorithm 2 if v₁^{opt} and v denotes optimal and greedy solution sets of the Dual j-MDD problem, which is a problem of finding the set V={x₁, . . . , xₚ} ∈ S_{d}, such that max_{1≦i≦p}d_{E}(f(x₁)) is minimized, with δᵥ=η and δᵥ=η/2, respectively, then, the optimality violation of the greedy algorithm is at least as good as the optimal algorithm. Namely, ξ_{E}(V)≦ξ_{E}(v_{J}^{opt}) and |V|=J. V₁^{opt} denotes an optimal solution of Dual j-MDD problem with the optimal value of δ*, i.e., d_{E}(f(x))≦δ* for all x ∈ V₁^{opt}, and δᵥ=η, i.e., dₓ(x₁, x₂)≧η for all distinct x₁, x₂ ∈ V*. In (2) of iteration j of Algorithm 2, for each x ∈ V₁^{opt} with dᵥ(x)<η/2 there is a solution x̅ ∈ V such that dₓ( x̅, x)<η/2. Moreover, for each x̅ ∈ V there is at most one x ∈ V₁^{opt} such that dₓ( x̅, x)<η/2. That follows from dₓ(x₁, x₁)≧η for all distinct x₁, x₁ ∈ V₁^{opt} and the triangle inequality of metric dₓ(∵). In each iteration j of 2 holds |V|<j, therefore there exists a feasible solution x ∈ V* with d_{E}(f(x))≦δ*. Dual MDD optimization problem in (2) minimizes d_{E}(f(x)). Finally, in the last iteration of (3), |V|=J.

The methods as described above may be used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in^{.}some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the term a processor, a network, a node, and a client terminal is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the compositiOn or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of identifying a set of designs compliant with one or more constraints, comprising:
providing an objective space of at least one objective and a design variables space;
examining a plurality of designs which comply with at least one constraint of said at least one objective;
identifying, according to said examination, a high diversity set comprising members from said plurality of designs which have corresponding design variables, in said design variables space, with a greater diversity value than the diversity value of respective corresponding design variables of a set from at least one set from said plurality of designs; and
outputting said high diversity set.

2. The method of claim 1, wherein said identifying comprises:
identifying an efficient frontier in said objective space;
identifying a initial set of multi objective designs on said efficient frontier;
identifying for each member of said initial set corresponding design variables;
maximizing said diversity value in a temporary set comprising said initial set by adjusting in said objective space, in each member of said initial set, any of said at least one objective without violating said at least one constraint; and
identifying said temporary set as said high diversity set.

3. The method of claim 2, wherein said at least one constraint is defined as a distance from said efficient frontier.

4. The method of claim 3, wherein said maximizing is performed while said distance is minimized and a minimal distance between corresponding design variables in said design variables space is maintained.

5. The method of claim 1, wherein said identifying comprises optimizing said designs while a minimum diversity value between corresponding design variables of said designs in said design variables space is maintained.

6. The method of claim 1, wherein said diversity value of said corresponding design variables is greater than a respective diversity value pertaining to at least one set of members from said plurality of designs.

7. The method of claim 1, wherein said providing comprises receiving a definition of at least one of said objective space and said design variables space from a user.

8. The method of claim 1, wherein said examining comprises iteratively examining a plurality of optional designs which comply with said at least one constraint.

9. The method of claim 1, further comprising receiving a message defining at least one of said at least one constraint and said at least one objective; wherein said outputting is performed in response to said message.

10. The method of claim 1, wherein said plurality of designs are identified using an efficient frontier algorithm, said at least one constraint being defined as a distance from an efficient frontier curve.

11. The method of claim 1, wherein a partial explored efficient frontier is used to identify a plurality of initial designs and then, in a plurality of iterations, a plurality of temporary sets are calculated to identify said high diversity set.

12. The method of claim 1, wherein each said design is selected from a group consisting of a product design, a process design, a financial design, an aircraft design, a mechanical design, an oil and gas industry design, and an automobile design.

13. A computer program product for identifying a set of designs compliant with one or more constraints, the computer program product comprising:
a computer readable storage medium having computer readable program code embodied therewith, the computer readable program code comprising: computer readable program code configured to provide an objective space of at least one objective and a design variables space;
computer readable program code configured to examine a plurality of designs which comply with at least one constraint of any of said at least one objective;
computer readable program code configured to identify, according to said examination, a high diversity set comprising members from said plurality of designs which have corresponding design variables, in said design variables space, with a greater diversity value than respective corresponding design variables of a set from at least one set from said plurality of designs; and
computer readable program code configured to output said high diversity set.

14. A system of identifying a set of designs compliant with a plurality of constraints of one or more objectives, comprising:
a processor;
a database which defines an objective space of at least one objective and a design variables space;
a designs module which examines a plurality of designs which comply with at least one constraint any of said at least one objective and identifies accordingly a high diversity set comprising members from said plurality of designs which have corresponding design variables in said design variables space with a diversity value that is greater than a respective diversity value pertaining to at least one set of members from said plurality of designs; and
an output interface which outputs said high diversity set.

15. The system of claim 14, wherein said system is implemented as a software as a service (SaaS).

16. The system of claim 14, wherein said system is implemented as a feature of a design platform.

17. A computer program product stored on a computer-readable medium, the computer program product comprising a computer program code, for a method of identifying a set of designs compliant with a plurality of constraints of at least one objective, comprising:
providing an objective space of at least one objective and a design variables space;
examining a plurality of designs which comply with at least one constraint of any of said at least one objective;
identifying, according to said examination, a high diversity set comprising members from said plurality of designs which have corresponding design variables in said design variables space with a diversity value that is greater than a respective diversity value pertaining to at least one set of members from said plurality of designs; and
outputting said high diversity set.

18. A method of identifying a set of designs compliant with one or more constraints, comprising:
providing an objective space of at least one objective and a design variables space;
examining a plurality of designs which comply with at least one constraint of any of said at least one objective;
calculating an efficient frontier in said objective space according to said at least one constraint;
identifying, according to said examination, a high diversity set comprising members from said plurality of designs which having a minimal distance from said efficient frontier and have corresponding design variables in said design variables space with a predefined diversity value; and
outputting said high diversity set.

19. The method of claim 18, wherein said identifying comprises iteratively identifying a temporary set of designs on said efficient frontier to minimize a distance between respective said designs in said objective space and said efficient frontier in each iteration while a distance between said corresponding design variables may be set to no less than said predefined diversity value.

20. The method of claim 18, wherein said identifying comprises:
identifying an efficient frontier in said objective space;
identifying a initial set of multi objective designs on said efficient frontier;
identifying for each member of said initial set corresponding design variables;
maximizing said diversity value in a temporary set comprising said initial set by adjusting in said objective space, in each member of said initial set, any of said at least one objective without violating said at least one constraint; and
identifying said temporary set as said high diversity set.
